(19) United States
(12) Patent Application Publication
(10) Pub. No.: US 2005/0201762 A1
(43) Pub. Date: Sep. 15, 2005

(54) Optical RZ-duobinary transmission system with narrow bandwidth optical filter

(76) Inventors: Lothar Benedict Erhard Josef Moeller, Middletown, NJ (US); Chongjin Xie, Morganville, NJ (US)

Correspondence Address: MOSER, PATTERSON & SHERIDAN, LLP/;LUCENT TECHNOLOGIES, INC, 595 SHREWSBURY AVENUE, SHREWSBURY, NJ, 07702, US

(21) Appl. No.: 10/799,101

(22) Filed: Mar. 12, 2004

(51) Int. Cl. H04B 10/06

(52) U.S. Cl. 398/202

(57) ABSTRACT

Simultaneous tolerance of system nonlinearities and chromatic dispersion in an optical transmission system using return-to-zero (RZ) duobinary signaling is achieved by filtering the received signal in the optical domain with a bandpass filter having a bandwidth B substantially equal to the bit-rate of the RZ-duobinary data signal. The use of an optical bandpass filter in a receiver for RZ-duobinary signals maintains the expected tolerance of system nonlinearities and simultaneously increases significantly the chromatic dispersion tolerance of the signals.

### FIELD OF THE INVENTION

This invention relates to the field of optical RZ-duobinary transmission systems and, more specifically, to an optical receiver for RZ-duobinary signals incorporating a narrow bandwidth optical filter.

### BACKGROUND OF THE INVENTION

Advanced modulation formats are considered to be of great importance for the development of the next generation of optical transmission networks. Among the various modulation formats, optical duobinary modulation has attracted much attention due to its compact spectrum and good transmission performance. Choice of a format depends, in part, on the ability to tolerate system nonlinearities and chromatic dispersion without impairing the receiver sensitivity.

A non-return-to-zero duobinary (NRZ-duobinary) modulation format can tolerate about three times more chromatic dispersion than the ordinary NRZ format. Chromatic dispersion tolerance makes NRZ-duobinary a potential candidate for metro-optical networks because, through the use of NRZ-duobinary signaling, expensive dispersion compensation modules (DCMs) that are currently used in optical networks to combat the problem can be eliminated. The dispersion tolerance of NRZ-duobinary transmission mainly results from the use of a bandwidth limiting filter in the transmitter that eliminates the signal spectrum beyond a half bit-rate away from the carrier. But, as a direct result of bandwidth limiting at the transmitter, the receiver sensitivity is degraded by several dB as compared with the sensitivity of an intensity modulation direct detection receiver normally used for reception of ordinary NRZ signals.

Another modulation format for duobinary signaling, RZ-duobinary, achieves complementary performance to the NRZ-duobinary. It was recently demonstrated, both numerically and experimentally, that RZ-duobinary signaling is more tolerant to transmission system nonlinearities than ordinary RZ for high speed, pseudo-linear transmission systems operating at data rates of 40 Gbps per channel and higher. In view of its system nonlinearity tolerance alone, RZ-duobinary signaling is an attractive modulation format for high-speed long-haul transmission systems. But the performance of RZ-duobinary against chromatic dispersion is no better than ordinary RZ signals.

In order to improve the performance against chromatic dispersion, one well-known approach is to introduce dispersion compensators into the transmission system. These devices are either fixed or tunable and are relatively expensive. In metro-optical systems, dispersion generally grows with increasing transmission distance. It is necessary to use fixed or even tunable dispersion compensators to compensate the growing dispersion in the system. Similarly, in long-haul optical transmission systems having lengthy fiber links, temperature and outside environmental changes induce dispersion variations and degrade the system performance. As a result, if the modulation formats such as RZ-duobinary and other RZ modulation formats do not have enough dispersion tolerance, tunable dispersion compensators have to be utilized in the receiver at a significant increase in system cost.

Nowhere does the prior art teach an optical system using RZ-duobinary modulation that simultaneously obtains the benefits of chromatic dispersion tolerance and system nonlinearity tolerance without the added expense of fixed or tunable dispersion compensation elements.

### SUMMARY OF THE INVENTION

Simultaneous tolerance of system nonlinearities and chromatic dispersion in an optical transmission system using return-to-zero (RZ) duobinary signaling is achieved simply, inexpensively, and without the use of expensive dispersion compensation elements by filtering the received signal in the optical domain with a bandpass filter having a bandwidth B substantially equal to a bit-rate of the RZ-duobinary signal. In accordance with the principles of the present invention, the use of an optical bandpass filter in a receiver for RZ-duobinary signals maintains the expected tolerance of system nonlinearities and simultaneously increases significantly the chromatic dispersion tolerance of the signals.

In one embodiment of the invention, the bandwidth of the filter is varied to be in a range of bandwidths from 0.7×B Hz through about 1.3×B Hz. This variation allows the system designer to realize an overall improvement that balances receiver sensitivity against chromatic dispersion tolerance. It has been found that decreasing the filter bandwidth can increase the dispersion tolerance while simultaneously reducing the receiver sensitivity. Detuning of the filter center frequency by ±15% has also been found to be allowable and, in certain instances, advantageous.

### BRIEF DESCRIPTION OF THE DRAWINGS

The teachings of the present invention can be readily understood by considering the following detailed description in conjunction with the accompanying drawings, in which:

FIG. 1 shows a simplified block diagram representation of an optical transmission system realized in accordance with the principles of the invention;

FIG. 2 shows a graphical comparison of the required OSNR versus chromatic dispersion for two different bandwidth optical bandpass filters in the system of FIG. 1;

FIG. 3 shows a comparison between eye diagrams for the system of FIG. 1 operating with high chromatic dispersion and different optical bandpass filters;

FIG. 4 shows a comparison between NRZ-duobinary signaling and RZ-duobinary signaling for required OSNR versus optical filter bandwidth.

### DETAILED DESCRIPTION OF THE INVENTION

Duobinary signaling offers a compact spectrum and good transmission performance in optical transmission systems. The NRZ and RZ-duobinary formats offer complementary results. NRZ-duobinary signaling tolerates chromatic dispersion well while being less tolerant to system nonlinearities; RZ-duobinary signaling, on the other hand, tolerates system nonlinearities well while being less tolerant to chromatic dispersion. System nonlinearities include, but are not limited to, inter-channel and intra-channel impairments such as four-wave mixing and cross-phase modulation.

Since NRZ-duobinary signaling exhibits complementary traits to RZ-duobinary signaling, efforts to optimize system and receiver performance tend to be successful in one regime and not in the other. For example, optical filters are placed in or near the optical receiver in order to reject amplified spontaneous emission (ASE) noise and, thereby, reduce signal-independent ASE-ASE beat noise. If a too narrow filter is chosen for this task, then it can introduce severe intersymbol interference for NRZ signals causing eye closures and raising the signal-ASE beat noise in the receiver. On the other hand, a too narrow filter for RZ signals will not only cause severe intersymbol interference but will also cause rejection of significant portions of the input pulse energy, leading to lower electrical signal amplitudes after photodetection and worse receiver performance. So experts in the field have believed that wider band filtering is preferred over too narrow band filtering because the degrading effects of increased noise power is found to be less severe than either the intersymbol interference problem or the problem of spectrally truncating the input signal. In fact, these experts suggest that the optimum optical filter bandwidth should be about two to three times the data rate for NRZ signals and about three times the data rate for RZ signals. See, for example, P. Winzer et al., “Optimum Filter Bandwidths for Optically Preamplified NRZ Receivers,” J. Lightwave Technology, Vol. 19, No. 9, pp. 1263-73, September 2001.

But narrowband optical bandpass filters have been introduced into NRZ and NRZ-duobinary signaling systems for a variety of reasons. In one experiment, an optical bandpass filter was added to the transmitter output to extend the dispersion-limited transmission distance for the NRZ system. The optical bandpass filter was designed to have a passband of approximately the bit rate of the NRZ signal. That is, the filter passband limits the optical field to a band of one-half the bit rate away from the carrier. See, for example, S. Walklin et al., “On the Relationship Between Chromatic Dispersion and Transmitter Filer Response in Duobinary Optical Communication Systems,” IEEE Photonics Technology Letters, Vol. 9, No. 7, pp. 1005-7, July 1997. In another experiment, an optical bandpass filter is introduced before the optical-to-electrical conversion stage of the receiver for a high speed NRZ-duobinary transmission system in order to improve receiver sensitivity. The passband is approximately equal to the bit rate of the NRZ-duobinary data signal. See, for example, X. Zheng et al., “Receiver Optimization for 40-Gb/s Optical Duobinary Signal,” IEEE Photonics Technology Letters, Vol. 13, No. 7, pp. 744-6, July 2001.

More recently, narrowband optical bandpass filters of varying bandwidths have been introduced into an RZ signaling system. In one technique, it was suggested that the distorting effects of polarization mode dispersion (PMD) in an ordinary RZ signaling system would be mitigated by placing a PMD compensator at the transmitter end of the transmission system in combination with an optical narrow bandpass filter at the receiver end of the system. The passband of the filter was tested at values equal to and exceeding the bit rate of the RZ data signal. In a high order PMD environment for an RZ system, the combination of PMD compensators with the narrow bandpass optical filter works well to mitigate the PMD if the passband is approximately equal to the bit rate of the RZ data signal. However, if PMD is effectively non-existent, then this combination causes a system penalty unless the narrowband optical filter is replaced by a wider optical bandpass filter having a passband equal to approximately two to three times the bit rate of the RZ data signal. See, for example, L. Moller et al., “Higher Order PMD Distortion Mitigation on Optical Narrow Bandwidth Signal Filtering,” IEEE Photonics Technology Letters, Vol. 14, No. 4, pp. 558-60, April 2002.

In all the systems described above, there is an attempt made to balance changes in receiver sensitivity, also known as back-to-back receiver sensitivity, with the gains in increasing tolerance to either chromatic dispersion or system nonlinearities. No system described above optimizes the performance in all three areas at once. Instead, performance penalties are accommodated in one or more areas while realizing gains in another area. Moreover, none of the techniques described above have been proposed for use with RZ-duobinary signaling.

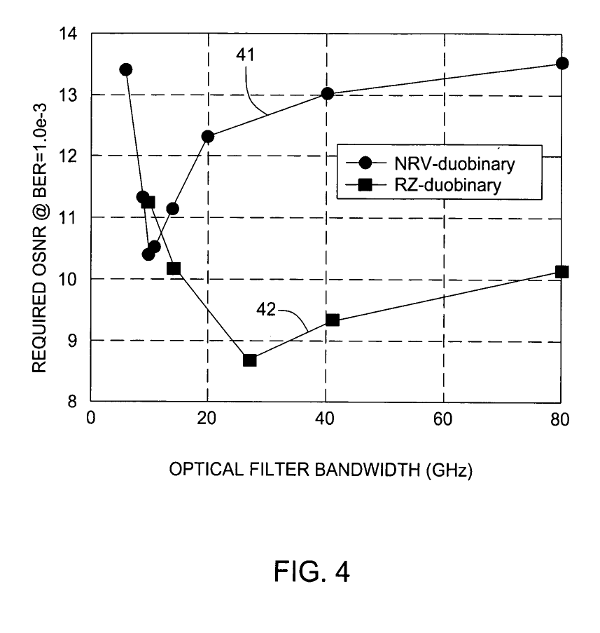

RZ-duobinary systems provide a degree of protection against transmission nonlinearities, but they suffer from chromatic dispersion. Attempts to extend any of the teachings of the prior art on narrow bandwidth optical bandpass filters to RZ-duobinary systems would lead one to a conclusion that these techniques actually degrade system performance significantly. To that end, the present inventors measured a required optical signal-to-noise ratio (OSNR) for back-to-back operation in a 10 Gbps optical transmission system having NRZ-duobinary signals and RZ-duobinary signals, wherein the system included an optical bandpass filter at the receiver. The results of this measurement are shown in FIG. 4 where OSNR is plotted against the bandwidth of the optical bandpass filter at the receiver and the system bit-error-rate (BER) is maintained constant at 1×10⁻³ for either NRZ-duobinary or RZ-duobinary signaling. Since the next generation of optical networks are expected to run with forward error correction (FEC) coding, the system performance in all tests described herein was measured at a BER of 1×10⁻³, which approximates the threshold for enhanced FEC with 7% overhead.

Curve 41 relates to 10 Gbps NRZ-duobinary signaling and curve 42 relates to RZ-duobinary signaling. OSNR was measured in 0.1 nm noise bandwidth. Curve 41 shows that, in order to achieve a minimum OSNR, the optimum optical bandwidth of the optical bandpass filter for back-to-back NRZ-duobinary signaling is about 10 GHz. (one times bit rate for the NRZ data signal). This bandwidth is smaller than the predicted optimum bandwidth for ordinary NRZ signaling. For 10 Gbps RZ-duobinary signaling, the optimum optical filter bandwidth from curve 42 is about 27 GHz. (almost three times the bit rate), which is close to the optimum bandwidth predicted for conventional RZ signaling.

Reduction of the optical filter bandwidth can assist in reducing ASE noise in the receiver and, in turn, can improve the system sensitivity as long as the filter does not induce significant signal loss and distortions at the receiver. From curve 41, it is clear that a bandwidth reduction down to the bit rate (i.e., from 20 GHz. to 10 GHz.) for NRZ-duobinary also creates almost 2 dB improvement in the OSNR. In contrast, as shown in curve 42, a similar bandwidth reduction down to the bit rate for RZ-duobinary signaling (i.e., from 27 GHz. to 10 GHz.) produces a 3 dB penalty in the required OSNR. As a result of this analysis, if a narrowband optical bandpass filter were selected for use at the receiver, one would be expected to be operating an NRZ-duobinary optical system because of the gains afforded as opposed to the penalties connected with operation in an RZ-duobinary optical system. Thus, the prior art appears to teach away from utilizing a narrow bandpass optical filter at the receiver in an RZ-duobinary optical transmission system.

In accordance with the principles of the present invention, an RZ-duobinary optical transmission system operating at a data bit rate B bits per second is enhanced by including an optical bandpass filter at the receiver wherein the passband of the filter is approximately B Hz. Not only does the resulting system realize the expected benefits of RZ-duobinary signaling, namely, system nonlinearity tolerance, but it also realizes improved chromatic dispersion performance without seriously degrading the receiver sensitivity.

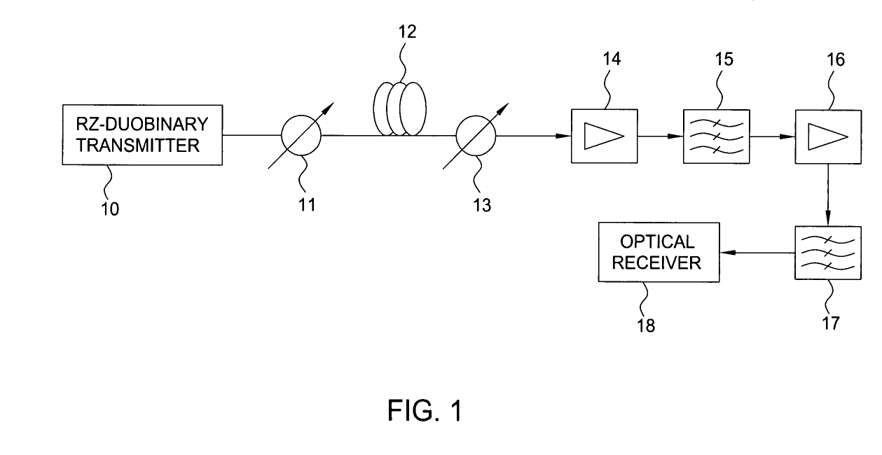

A typical optical transmission system for RZ-duobinary signals realized in accordance with the principles of the present invention is shown in FIG. 1. FIG. 1 shows the simplified block diagram of the optical transmission system including a transmitter, a receiver, and optical fiber providing a transmission medium connecting the transmitter to the receiver.

Transmitter 10 generates an RZ-duobinary optical signal in response to an input data stream. Attenuator 11 is adjustable, programmably or manually, to control an input level of the RZ-duobinary signal from transmitter 10. Attenuated RZ-duobinary optical signals from attenuator 11 are coupled into optical transmission medium 12. Transmission medium 12 is generally realized as a length of optical fiber. A receiver pre-amplifier stage comprises optical amplifier 14 and narrow bandpass filter 17. The pre-amplifier stage amplifies the received RZ-duobinary signal and reduces ASE noise. In accordance with the principles of the present invention, the passband of narrowband optical bandpass filter 17 is chosen to be approximately B Hz, where B bps is the bit rate of the RZ-duobinary data. Optical receiver 18 then converts the received optical signal from filter 17 into an electrical signal and recovers the data therefrom. In general, receiver 18 is commonly a direct detection receiver.

It will be appreciated by those persons skilled in the art that transmission medium 12 may include optical fibers selected from many different categories of fiber such as polarization maintaining fiber, dispersion compensating fiber and the like. In addition, optical transmission medium 12 can be configured to include multiple spans in which each span includes optical amplifier apparatus such as, but not limited to, an erbium doped fiber amplifier and a length of optical fiber to transport the optical signals.

Attenuator 13 is included in the system shown in FIG. 1 as an element necessary to complete experimental tests whose results are described below. Attenuator 13 is employed to adjust the level of optical signals received from transmission medium 12 and the OSNR at the receiver so that various system measurements can be carried out. It is not expected that that attenuator 13 would be necessary for a deployed optical transmission system.

The optical transmission system shown in FIG. 1 includes elements necessary to conduct experimental tests on the RZ-duobinary optical transmission system as well as those elements necessary to practice the principles of the present invention. In one example from experimental practice, a commercially available duobinary transmitter was used to generate a 9.953 Gbps NRZ-duobinary signal. The NRZ-duobinary signal was input to a pulse carver in order to produce a 33% duty-cycle RZ-duobinary optical signal which was then transmitted to the optical receiver via the transmission medium. Chromatic dispersion was controlled by using different lengths of specific optical fibers so that the required chromatic dispersion could be achieved in the experiments. Optical launch power into the fiber transmission medium was kept low to avoid stimulation of nonlinear effects in the transmission medium. Attenuator 13 was adjusted to control the optical signal power entering optical amplifier 14 allowing the ability to change the OSNR at the input of narrow bandwidth optical bandpass filter 17 in the receiver. Both the center frequency and the filter bandwidth of optical filter 17 were adjustable to compile the experimental results and demonstrate the narrow bandwidth optical filtering concept for RZ-duobinary optical signals. In one example from experimental practice, filter 17 has the intensity response close to a 2^{nd}-order super-Gaussian filter.

RZ-duobinary optical transmitters are well known in the art. In one example from the art (not shown in the drawings herein), an electrical modulation (data) signal of bit rate B is processed by either a “delay & add” circuit or a duobinary filter whose bandwidth is typically between 0.25 B and 0.4 B. The processed data signal is then supplied to an optical modulator driven by a CW optical source. The optical modulator generates an optical data signal at the wavelength of interest. This optical data signal is coupled into a pulse carver to narrow the pulse width for RZ-duobinary transmission.

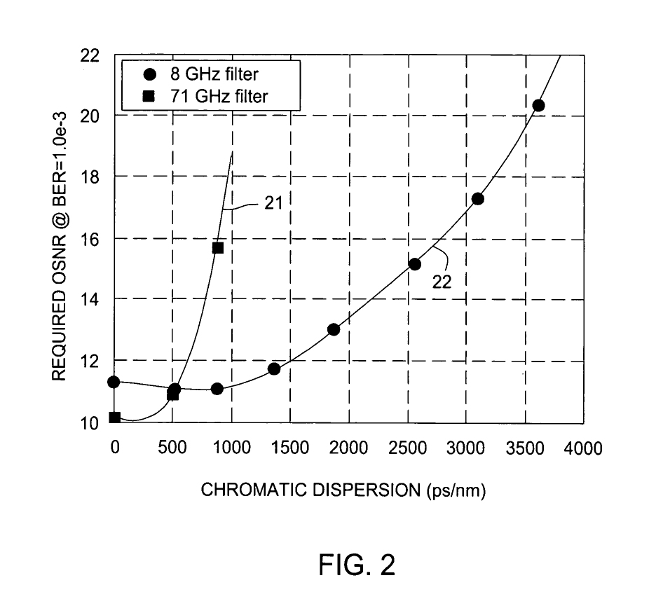

In order to visualize the effect of adding a narrow bandwidth and to determine any amount of improvement, a comparative test was run on the system in FIG. 1 wherein required OSNR for a fixed BER was measured for two different bandwidth optical bandpass filters as the chromatic dispersion was varied. FIG. 2 shows the graphical comparison of this test in which the required OSNR at a BER of 1×10⁻³ versus chromatic dispersion was measured for the 10 Gbps RZ-duobinary signaling system in FIG. 1 operating with either an 8 GHz (curve 22) or a 71 GHz (curve 21) optical bandpass filter 17. From an analysis of the results in FIG. 2, it is apparent that the narrow bandwidth optical filter significantly improves the system tolerance to chromatic dispersion.

According to the results plotted in curve 21, the 10 Gbps RZ-duobinary optical system operating with a 71 GHz wideband optical filter 17 can tolerate about ±600 ps/nm chromatic dispersion for 2 dB OSNR penalty. This result corresponds to a similar penalty when the signals experience ±37.5 ps/nm in a 40 Gbps RZ-duobinary system. According to the results plotted in curve 22, the 10 Gbps RZ-duobinary optical system operating with an 8 GHz narrowband optical filter can tolerate about ±2000 ps/nm chromatic dispersion for 2 dB OSNR penalty over the zero dispersion case. This result corresponds to a similar penalty when the signals experience ±125 ps/nm in a 40 Gbps RZ-duobinary system. In comparison, the use of a narrow optical bandpass filter at the receiver in the RZ-duobinary optical transmission system provides a chromatic dispersion tolerance improvement about three times greater than that afforded by the wider bandwidth filter when the penalty is maintained constant.

A 1.5 dB sensitivity degradation for back-to-back RZ-duobinary signaling with an 8 GHz optical bandpass filter has been measured and understood to be due to the larger loss of the signal power as compared to noise. Despite this degradation, if the OSNR level is maintained at the same level, for example, an OSNR level of 12 dB, then the wider bandwidth filter introduces a 2 dB penalty at ±600 ps/nm chromatic dispersion whereas the narrow bandwidth filter introduces a 0.5 dB penalty at ±1500 ps/nm chromatic dispersion. This result corresponds to a chromatic dispersion tolerance of ±94 ps/nm in a 40 Gbps RZ-duobinary system. In comparison, the use of a narrow optical bandpass filter at the receiver in the RZ-duobinary optical transmission system provides a chromatic dispersion tolerance improvement of about 2.5 times greater than that provided by the wider bandwidth optical filter when the required OSNR at a given BER is held constant. In addition, FIG. 2 indicates that, by narrowing the bandwidth of the optical filter to be in the vicinity of the bit rate B, it is possible to adjust the receiver sensitivity and chromatic dispersion tolerance according to the other system requirements, thereby adding flexibility to the system design.

In an example from experimental practice, it is preferred that the filter bandwidth be approximately equal to the data bit rate. However, the bandwidth can be adjusted to provide more or less chromatic dispersion tolerance and thereby less or more receiver sensitivity. It has been determined from experimental practice that a range of passbands from 0.7×B Hz through and including 1.3×B Hz permits flexible system design while realizing the benefits of the present invention.

In another example from experimental practice, it has been determined that the center frequency of the passband is desirably positioned at or near the center frequency of the optical data signal. But it has also been determined that the center frequency of the passband for the narrowband optical bandpass filter can be detuned from the center frequency by as much as ±0.1×B Hz or ±15% of B Hz. Up to this amount of detuning has been found to still realize the positive benefits of the present invention without measurably degrading overall system performance.

Optical bandpass filter 17 can be realized as an etalon or a fiber Bragg grating (FBG) or the like. Various types of optical bandpass filter arrangements are known in the art. Filter shape is an additional consideration for the system designer. While sharp cutoffs are preferred at the edges of the passband for filter 17, it is possible to design suitable bandpass filters having a Gaussian shape as well as higher order super-Gaussian shapes.

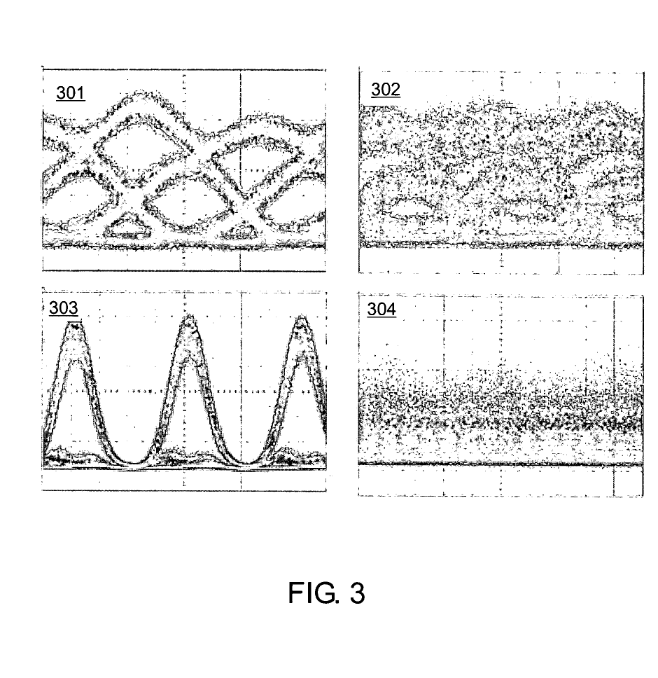

In order to demonstrate the improved chromatic dispersion tolerance of the RZ-duobinary optical transmission system of FIG. 1 operating with a narrow optical bandpass filter 17, eye diagrams were observed for back-to-back operation and for extremely high chromatic dispersion using the narrow optical bandpass filter 17. The eye diagram observations were repeated for a wide optical bandpass filter 17 under the same two conditions, namely, back-to-back operation and a high chromatic dispersion environment. The observed eye diagrams are shown in FIG. 3. Filter 17 in the narrow band case exhibited an 8 GHz passband, whereas the wideband case exhibited a 71 GHz passband. The high chromatic dispersion was measured at 3085 ps/nm for both sets of observations.

Eye diagrams 301 and 303 depict the results for back-to-back system operation using the narrow filter and wide filter, respectively. Both eye diagrams are relatively clean and open, as expected. Eye diagrams 302 and 304 depict the results for high chromatic dispersion operation (3085 ps/nm) using the narrow filter and wide filter, respectively. For the system including a wide bandwidth filter 17, there is effectively no signal information in the eye-diagram when the signals are exposed to the high chromatic dispersion. On the other hand, if the system includes a narrow bandwidth optical filter 17, there is only moderate distortion in the received eye diagram when the signals are exposed to the high chromatic dispersion. This comparison corroborates the graphical evidence from FIG. 2, namely, that inserting of a narrow bandwidth optical filter at the receiver of an RZ-duobinary system significantly enhances the chromatic dispersion tolerance of the system.

As a result, RZ-duobinary optical transmission together with narrow bandwidth optical filtering receiver can be used as a simple, cost effective alternative to dispersion compensation modules and the like in combating the deleterious effects of chromatic dispersion. In addition, the RZ signaling format sacrifices none of its tolerance of nonlinear impairments such as intra-channel four-wave mixing and intra-channel cross-phase modulation that limit high speed (e.g., 40 Gbps) optical transmission systems.

1. An optical receiver for receiving an RZ-duobinary optical signal at a bit rate B bits per second, the receiver comprising:
an optical bandpass filter responsive to the RZ-duobinary optical signal for filtering the signal within a passband of B Hz; and
an optical detector for recovering data from the filtered RZ-duobinary optical signal.

2. The optical receiver as defined in claim 1 wherein a center frequency of the optical bandpass filtered is detuned from a center frequency of the RZ-duobinary optical signal by an amount less than or equal to ±0.1×B.

3. An optical receiver for receiving an RZ-duobinary optical signal at a bit rate B bits per second, the receiver comprising:
an optical bandpass filter responsive to the RZ-duobinary optical signal for filtering the signal within a passband having a bandwidth greater than or equal to 0.7×B Hz and less than or equal to 1.3×B Hz; and
an optical detector for recovering data from the filtered RZ-duobinary optical signal.

4. A method for receiving a duobinary optical signal having a data bit rate of B bits per second, the method comprising the steps of:
bandpass filtering the signal through a passband substantially equal to B Hz; and
recovering data from the filtered signal, wherein the signal conforms to an RZ-duobinary signaling format.

5. The method as defined in claim 4 wherein a center frequency of the optical bandpass filtered is detuned from a center frequency of the RZ-duobinary optical signal by an amount less than or equal to ±0.1×B.

6. A method for receiving a duobinary optical signal having a data bit rate of B bits per second, the method comprising the steps of:
bandpass filtering the signal through a passband having a bandwidth greater than or equal to 0.7×B Hz and less than or equal to 1.3×B Hz; and
recovering data from the filtered signal, wherein the signal conforms to an RZ-duobinary signaling format.

7. An optical transmission system comprising:
an optical transmitter for generating an RZ-duobinary optical signal at a bit rate B bits per second;
an optical transmission medium coupled to the optical transmitter for supporting propagation the RZ-duobinary optical signal;
an optical bandpass filter coupled to an output of the optical transmission medium and being responsive to the RZ-duobinary optical signal for filtering the signal within a passband of B Hz; and
an optical detector for recovering data from the filtered RZ-duobinary optical signal.

8. The optical transmission system as defined in claim 7 wherein a center frequency of the optical bandpass filtered is detuned from a center frequency of the RZ-duobinary optical signal by an amount less than or equal to ±0.1×B.

9. An optical transmission system comprising:
an optical transmitter for generating an RZ-duobinary optical signal at a bit rate B bits per second;
an optical transmission medium coupled to the optical transmitter for supporting propagation the RZ-duobinary optical signal;
an optical bandpass filter coupled to an output of the optical transmission medium and being responsive to the RZ-duobinary optical signal for filtering the signal within a passband having a bandwidth greater than or equal to 0.7×B Hz and less than or equal to 1.3×B Hz; and
an optical detector for recovering data from the filtered RZ-duobinary optical signal.
